(19) United States
(12) Patent Application Publication
(10) Pub. No.: US 2007/0201387 A1
(43) Pub. Date: Aug. 30, 2007

(54) Information processing device, communication load distribution method

(75) Inventors: Yusuke Kurasawa, Nagano (JP); Toshitaka Yanagisawa, Kamiminochi-gun (JP); Tetsuya Kinoshita, Nagano (JP); Takashi Murayama, Nagano (JP); Toshiaki Takeuchi, Nagano (JP); Jun Takeuchi, Nagano (JP); Atsushi Shinohara, Nagano (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/384,295

(22) Filed: Mar. 21, 2006

(30) Foreign Application Priority Data
Dec. 19, 2005 (JP) 2005-365458

(51) Int. Cl. H04B 1/44; H04L 12/56

(52) U.S. Cl. 370/282; 370/400

(57) ABSTRACT

A node according to the present invention, in a node which is to be instructed by a master node and communicates with an electronic device, performs an activation query notification to the master node. If it is determined that a response from the master node has not been made, the electronic device is allowed to communicate without an instruction from the master node, and it is also determined whether any other node is connected or not. If it is determined that some other new node is connected, the node instructs the other new node to communicate with the electronic device.

### BACKGROUND OF THE INVENTION

1. Field of the Invention

The present invention relates to a system for performing load distribution of communication by using a plurality of nodes, and, more particularly, to a system which operates by using nodes in a master-slave relationship with a master node and a slave node.

2. Description of the Related Art

In recent years, in a network environment, a large amount of data has been communicated. Accordingly, it is required to communicate data more efficiently by distribution a load in the data communication.

In order to perform the load distribution of communication and make a path redundant, for example, a plurality of nodes is provided between a host computer and a plurality of mass storage devices and by using these nodes, the load distribution of communication is realized.

Generally, first, a master-slave relationship among a plurality of nodes is established, and then, a master node and slave nodes are set in advance. The master node performs data communication with a mass storage device or the like without an instruction from the other nodes, and the slave nodes perform data communication with a mass storage device or the like in accordance with an instruction from the master node. Thus, by using the plurality of nodes, the load distribution of communication in a network environment is realized.

FIG. 1 is a sequence view illustrating an incorporation process with a master node and a slave node.

In a case in which a master node 1 and a slave node 2 are set in advance, when the master node 1 and the slave node 2 are activated (steps S101, and S102), the master node 1 queries the slave node 2 whether the slave node 2 is activated or not (step S103). The slave node 2 responds to the master node 1 that the slave node 2 is activated (step S104). The master node 1 sets a state to be communicatable with a connected host computer and a connected mass storage device, and completes the setting (step S105 and S106). Then, while setting the state to be communicatable, the master node 1 acquires a master privilege for instructing the slave node 2 to communicate.

Next, the slave node 2 queries the master node 1 whether the master node 1 is activated or not (step S107). The master node 1 notifies the slave node 2 that an incorporating process between the master node 1 and the slave node 2 is required in order to balance a load in the communication with the host computer and the mass storage device (step S108). Here, the incorporating process is intended to set the master node and the slave node so that the master node and the slave node can communicate with the host computer and the mass storage device, and process a setting so that the slave node communicates in accordance with an instruction from the master node. The slave node 2 requests the master node 1 to perform an incorporating process and the incorporating process is performed in the master node 1 and the slave node 2 (steps S109 and S110). When the incorporating process is completed, the master node 1 notifies the slave node 2 of the completion of the incorporating process (step S111). After the slave node 2 receives the notification of the completion of the incorporating process, the slave node 2 completes the setting to be communicatable with the host computer and the mass storage device (step S112). The timing that the slave node 2 queries the master node 1 whether the master node 1 is activated or not (step S107) can be at the timing immediately after the slave node 2 is activated.

However, if performing the communication load distribution by making the communication path to be redundant by using the master node and the slave node, the following problems have to be considered.

FIG. 2 is a sequence view illustrating a case in which the master node is not normally operated.

In FIG. 2, the slave node 2 is activated (step S201) and the slave node 2 queries the master node 1 whether the master node 1 is activated or not (step S202). Here, the master node 1 is not activated and it is not possible to reply to the slave node 2 that the master node 1 is activated.

The slave node 2 counts for a predetermined period of time until the slave node 2 receives a reply from the master node 1. If there is no reply from the master node 1 even if the predetermined period of time has passed, the slave node 2 considers it as a time-out (step S203).

Then, the slave node is terminated without being activated (step S204).

Since the slave node 2 is not able to operate without the instruction from the master node 1, if the master node 1 is not able to operate, or the like, the slave node 2 is not able to communicate with the host computer and the mass storage device. Thus, there is no substantial advantage in the redundancy of the communication path.

FIG. 3 is a sequence view illustrating a case in which the master node 1 is not physically connected to the host computer, the mass storage device, or the like.

If the master node 1 and the slave node 2 are activated (steps S301, and S302), the slave node 2 queries the master node 1 whether the master node 1 is activated or not (step S303).

Then, if the master node 1 has not physically been connected to the host computer, the mass storage device, or the like, it is determined that the master node 1 is activated but is not communicatable (step S304).

The master node 1 replies to the slave node 2 that the master node 1 is not able to normally operate (step S305).

The slave node 2 is terminated without being activated (step S306). Here, the master node 1 also queries the slave node 2 whether the slave node 2 is activated or not (not shown in the drawing). The response of the slave node 2 to the query from the master node 1 is also not shown in the drawing.

Also in this case, since it is not possible for the master node 1 to communicate, it is also not possible for the slave node 2 to communicate with the host computer and the mass storage device. Thus, there is no substantial advantage in the redundancy of the communication path.

Further, in a case in which the master node 1 and the slave node 2 perform an incorporating process, and the communication load distribution is configured, if the slave node 2 is not able to communicate due to a failure in the slave node, the following problem occurs.

As a patent document regarding an information processing device for performing a communication load distribution and making a path redundant, the following is referred to. In Japanese Patent Application Laid-Open No. 02-065335, if a failure in a link which is connected to a node is detected, while the connecting state of the link is changed, an alternate path table to an adjacent node and the change of the using state of the link are notified to all nodes in a network.

Then, the notified node searches whether the link of which the state has changed is included in its alternate path table or not. If the link is included, the alternate path table is updated by rewriting the using state of the link of the alternate path table.

However, in the technique disclosed in the above patent document, there is the following problem.

That is, if the node in which the failure has occurred is the master node, slave nodes to which the alternate path is provided can communicate by updating the alternate path table. However, only the slave nodes which are configured for the node configuration in advance operate as the path for communication, and the communication load to the slave nodes increases.

To solve the problem, when the failure occurs to the master node or the slave nodes which are configured for the node configuration, a restoration of the node configuration is performed as shown in FIG. 4.

FIG. 4 is a conceptual illustration regarding the node configuration restoration.

Here, a case in which a failure occurred in a slave node is shown. However, a similar restoration work is performed if a failure occurs in the master node.

If a failure occurred in the slave node 2 in the node configuration 401 and the system went down and becomes uncommunicatable, in order to retain the communication load distribution and the redundant configuration of the path, a slave node 20 and the slave node 2 are switched by maintenance staff, or the like.

The slave node 20 has the same IP (Internet Protocol), WWN (World Wide Name), or the like as those of the slave node 2, and even if it switched to the slave node 2, the node configuration 40 works normally.

Then, the load distribution of the node configuration 40 is configured with the master node 1 and the slave node 20, and the communication with the host computer and the mass storage device is performed. Here, “master 1”, “slave 2”, and “slave 20” described in the master node 1, the slave node 2, and the slave node 20 respectively denotes the master node 1, the slave node 2, and the slave node 20. It is also shown that the master node 1, the slave node 2, and the slave node 20 store the node configuration as a communication list.

However, if a failure occurs in the slave node 2, the maintenance staff has to switch the slave node 2 to a new slave node and it is troublesome.

### SUMMARY OF THE INVENTION

Accordingly, it is an object of the present invention to retain the communication load distribution and the redundancy of the path by newly configuring a node configuration even if a failure occurs in the master node or the slave node without bothering the maintenance staff.

In an information processing device according to the present invention, the information processing device for communicating with an electronic device in accordance with an instruction from another information processing device connected to the electronic device includes connecting means for connecting to the other information processing device and is further connectable to a new or a plurality of new information processing devices, response monitoring means for performing an activation query notification which queries the other information processing device whether the other information processing device is activated or not, and monitoring a response to the activation query notification from the other information processing device, communication controlling means for allowing the electronic device to be communicatable without an instruction from the other information processing device if it is determined that the response has been made, information processing device connection determining means for determining whether any other new information processing device is connected by the connecting means if the response monitoring means determines that the response has not been made, and communication instructing means for instructing the other new information processing device to communicate with the electronic device if it is determined that the other new information processing device is connected in the information processing device connection determining means.

Further, in the information processing device according to the present invention, the response monitoring means monitors whether the response from the other information processing device has been made or not for a predetermined period of time, and if it is determined that the response has not been made after the predetermined period of time has passed, determines that the response has not been made.

Further, in an information processing device according to the present invention, the information processing device for communicating with an electronic device in accordance with an instruction from another information processing device connected to the electronic device includes connecting means for connecting to the other information processing device and is further connectable to a new or a plurality of new information processing devices, storage means for storing a communication list which describes that in the other information processing device and the information processing device, the other information processing device instructs the information processing device to communicate with the electronic device with each other, response monitoring means for performing an activation query notification which queries the other information processing device whether the other information processing device is activated or not, and monitoring a response to the activation query notification from the other information processing device, communication controlling means for allowing the electronic device to be communicatable without an instruction from the other information processing device if the response monitoring means determines that the response has not been made, information processing device connection determining means for determining whether any other new information processing device is connected by the connecting means if the response monitoring means determines that the response has not been made, communication instructing means for instructing the other new information processing device to communicate with the electronic device if the information processing device connection determining means determines that the other new information processing device is connected, and communication list updating means for updating the communication list so that the information processing device communicates without the instruction from the other information processing device and the other new information processing device communicates while the other information processing device does not communicate.

In a communication load distribution method according to the present invention, the communication load distribution method for communicating with an electronic device in accordance with an instruction from another information processing device connected to the electronic device includes a connecting step of connecting to the other information processing device and further allowing to be connectable to a new or a plurality of new information processing devices, a response monitoring step of performing an activation query notification which queries the other information processing device whether the other information processing device is activated or not, and monitoring a response to the activation query notification from the other information processing device, a communication controlling step of allowing the electronic device to be communicatable without an instruction from the other information processing device if it is determined that the response has not been made in the response monitoring step, an information processing device connection determining step of determining whether any other new information processing device is connected by the connecting step if it is determined that the response has not been made in the response monitoring step, and a communication instructing step of instructing the other new information processing device to communicate with the electronic device if it is determined that the other new information processing device is connected in the information processing device connection determining step.

In a communication load distribution program according to the present invention, the communication load distribution program for communicating with an electronic device in accordance with an instruction from another information processing device connected to the electronic device, the communication load distribution program directing a computer to perform a connecting step of connecting to the other information processing device and further allowing to be connectable to a new or a plurality of new information processing devices, a response monitoring step of performing an activation query notification which queries the other information processing device whether the other information processing device is activated or not, and monitoring a response to the activation query notification from the other information processing device, a communication controlling step of allowing the electronic device to be communicatable without an instruction from the other information processing device if it is determined that the response has not been made in the response monitoring step, an information processing device connection determining step of determining whether any other new information processing device is connected by the connecting step if it is determined that the response has not been made in the response monitoring step, and a communication instructing step of instructing the other new information processing device to communicate with the electronic device if it is determined that the other new information processing device is connected in the information processing device connection determining step.

According to the present invention, even if a failure occurs in a master node, a slave node is able to communicate, and a communication load distribution and a redundancy of a path can be retained by reconfiguring a new node configuration without bothering a maintenance staff.

Further, even if the node in which the failure occurred is rebooted after the reconfiguration of the node, it can be possible to communicate without contradiction in a node configuration capable of communicating with a host computer or the like.

### BRIEF DESCRIPTION OF THE DRAWINGS

FIG. 1 is a sequence view illustrating a known incorporating process of a master node and a slave node;

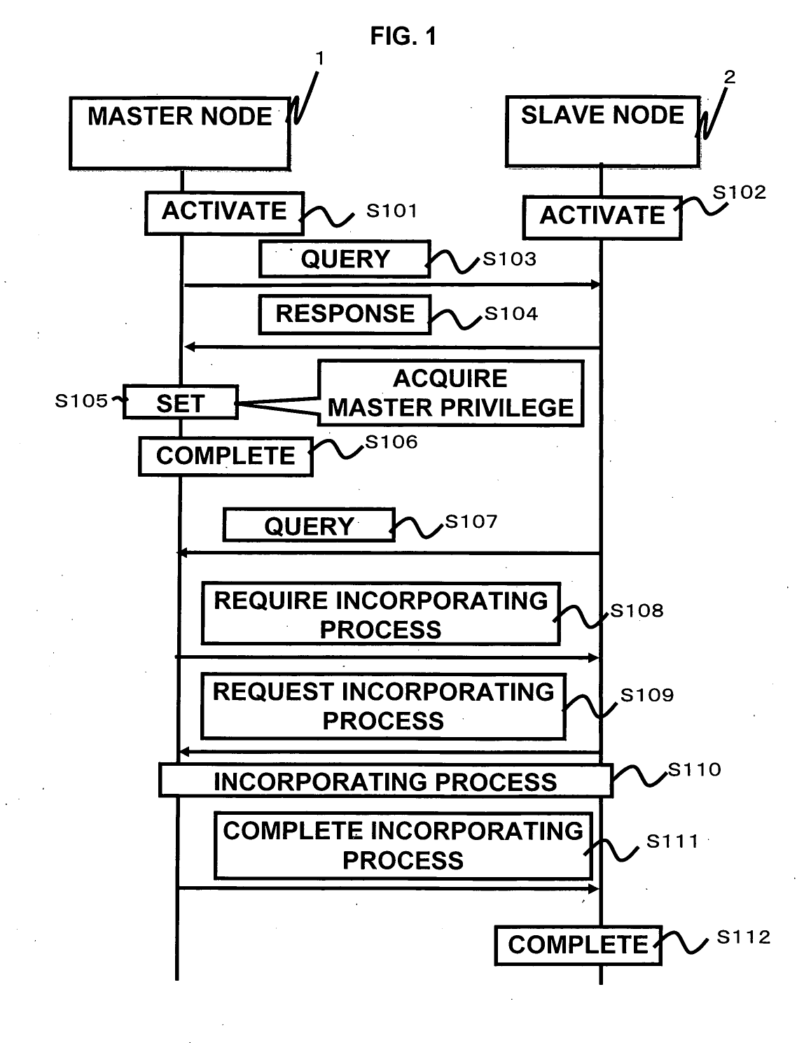

FIG. 2 is a sequence view illustrating a case in which a master node is not normally operating in a known art;

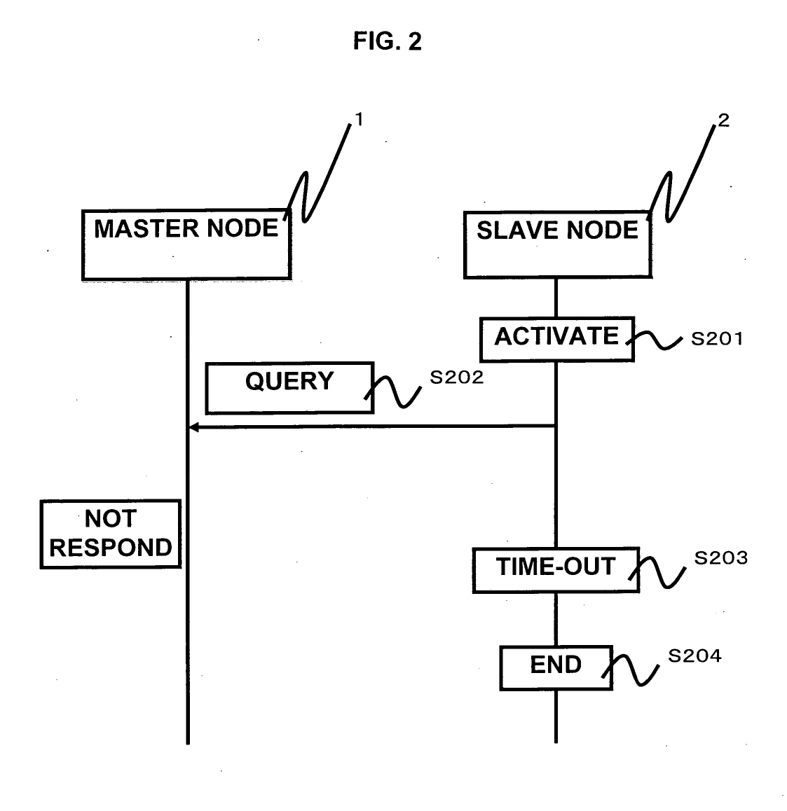

FIG. 3 is a sequence view illustrating a case in which a master node is not connected to a host computer or the like in a known art;

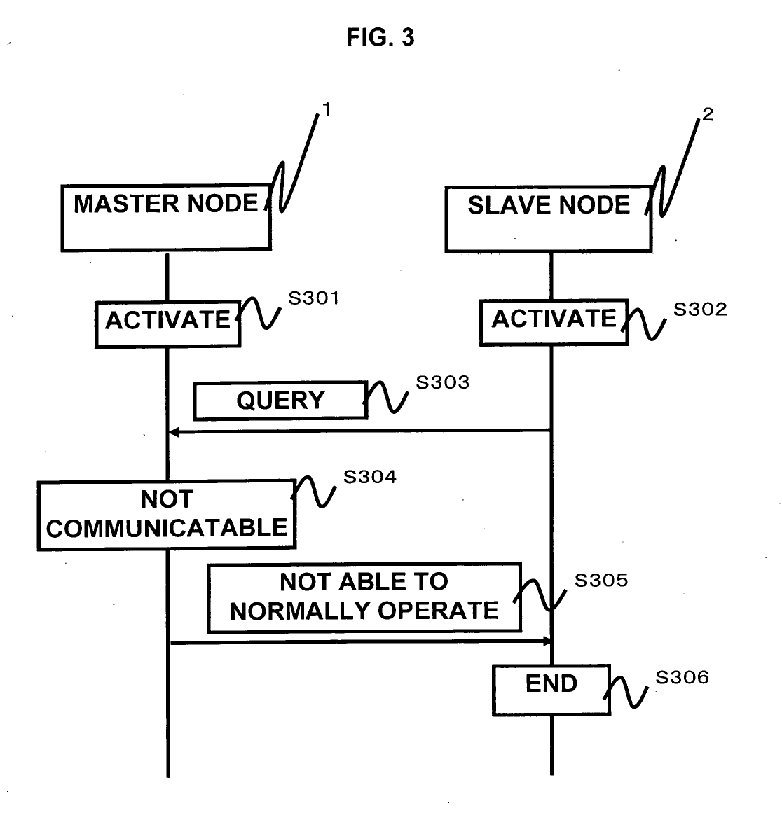

FIG. 4 is a conceptual view illustrating a node configuration restoration;

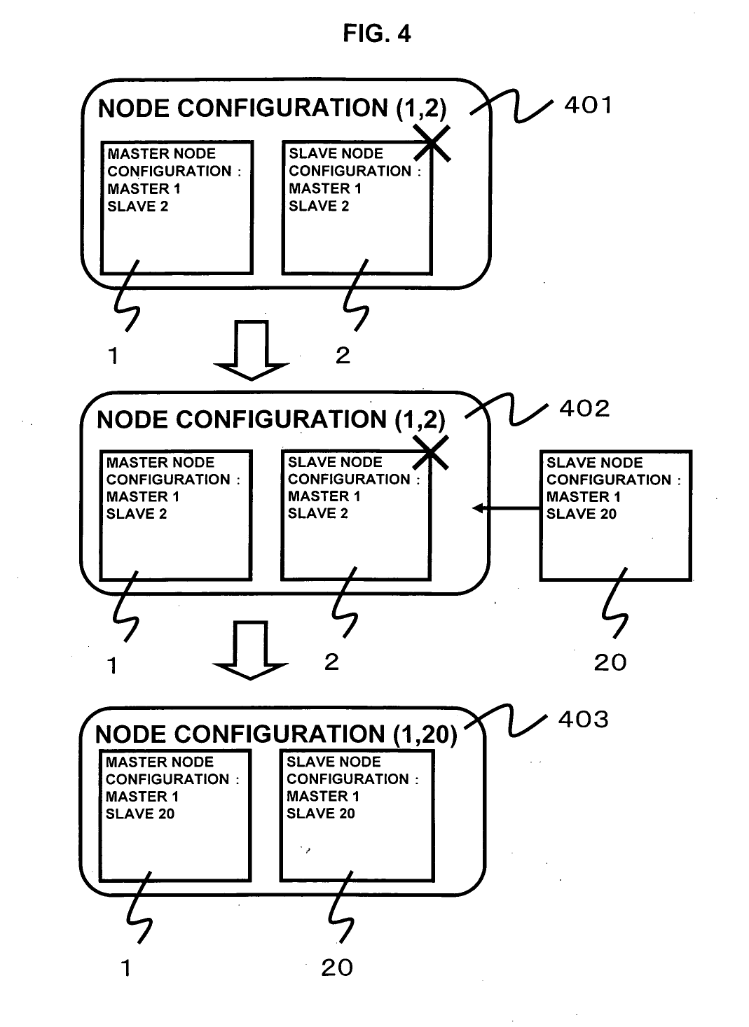

FIG. 5 is a conceptual view illustrating a communication system to which the present invention is applied;

FIG. 6 is a hard block diagram according to an embodiment of the present invention;

FIG. 7 is a sequence view illustrating a case in which a master node 7 is not normally operating according to an embodiment of the present invention;

FIG. 8 is a sequence view illustrating a case in which a master node is not connected to a host computer or the like according to an embodiment of the present invention;

FIG. 9 is a conceptual view illustrating a case in which restoring a slave node according to an embodiment of the present invention; and

FIG. 10 is a flowchart according to an embodiment of the present invention.

### DESCRIPTION OF THE PREFERRED EMBODIMENTS

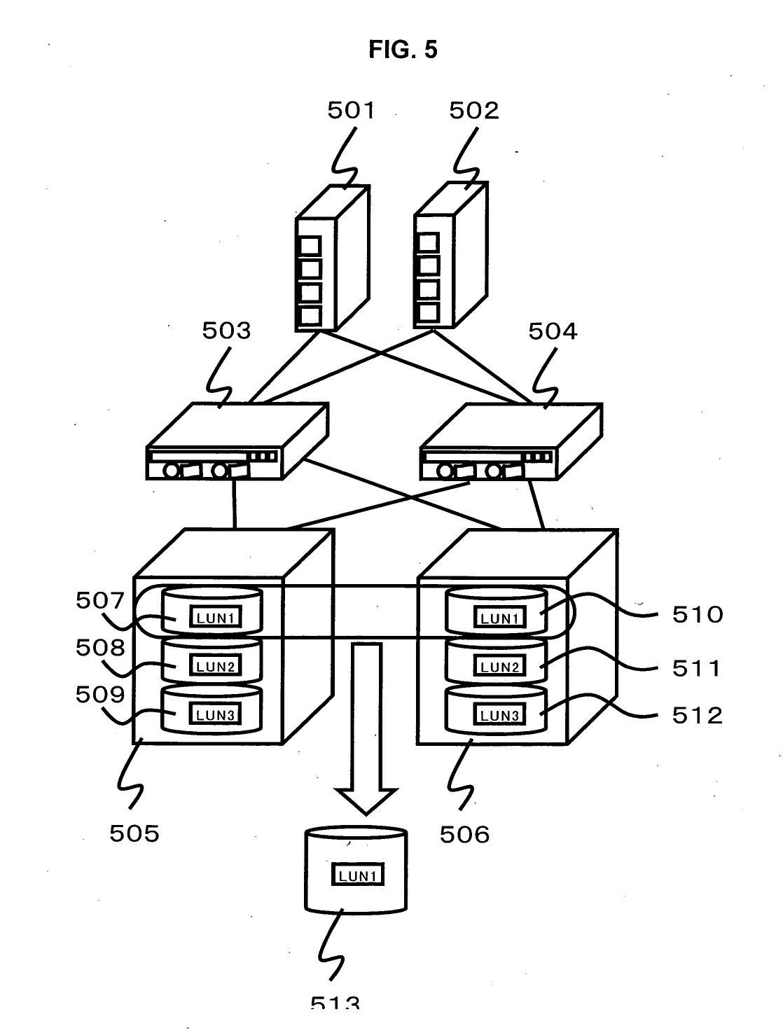

FIG. 5 is a conceptual view illustrating a communication system to which the present invention is applied.

The system according to an embodiment of the present invention includes a host computer 501, a host computer 502, a master node 503, a slave node 504, a RAID storage 505, and a RAID storage 506.

Both of the master node 503 and the slave node 504 are connected to the host computer 501, the host computer 502, the RAID storage 505, and the RAID storage 506.

The RAID storage 505 and the RAID storage 506 respectively includes hard disks 507, 508, and 509, and hard disks 510, 511, and 512. The term LUN in the drawing is an abbreviated expression of “Logical Unit Number”, and is used to identify each hard disk in the each RAID storage.

If the master node 503 and the slave node 504 transmit data among the RAID storage 505 and the RAID storage 506, the master node 503 and the slave node 504 consider the hard disk 507 and the hard disk 510 as a virtual hard disk 513, and communicates with the virtual hard disk.

By the structure, because of the virtual integration of the hard disk to communicate with, the master node 503 and the slave node 504 can perform high-speed communication.

Similarly, the hard disk 508 and the hard disk 511, and the hard disk 509 and the hard disk 512 are respectively structured as a virtual hard disk (not shown).

A node configuration for communication is configured by the master node 503 and the slave node 504. If it is not possible for the master node 503 to normally operate, a setting is processed so that the slave node 504 is able to communicate with the host computer 501, the host computer 502, the RAID storage 505, and the RAID storage 506 without an instruction from the master node 503.

Then, the slave node determines if any other node is connected in order to retain the communication load distribution. If some other node is connected to the slave node 504, a new configuration. with the other node is reconfigured so as to retain the communication load distribution. Here, the other node is not shown.

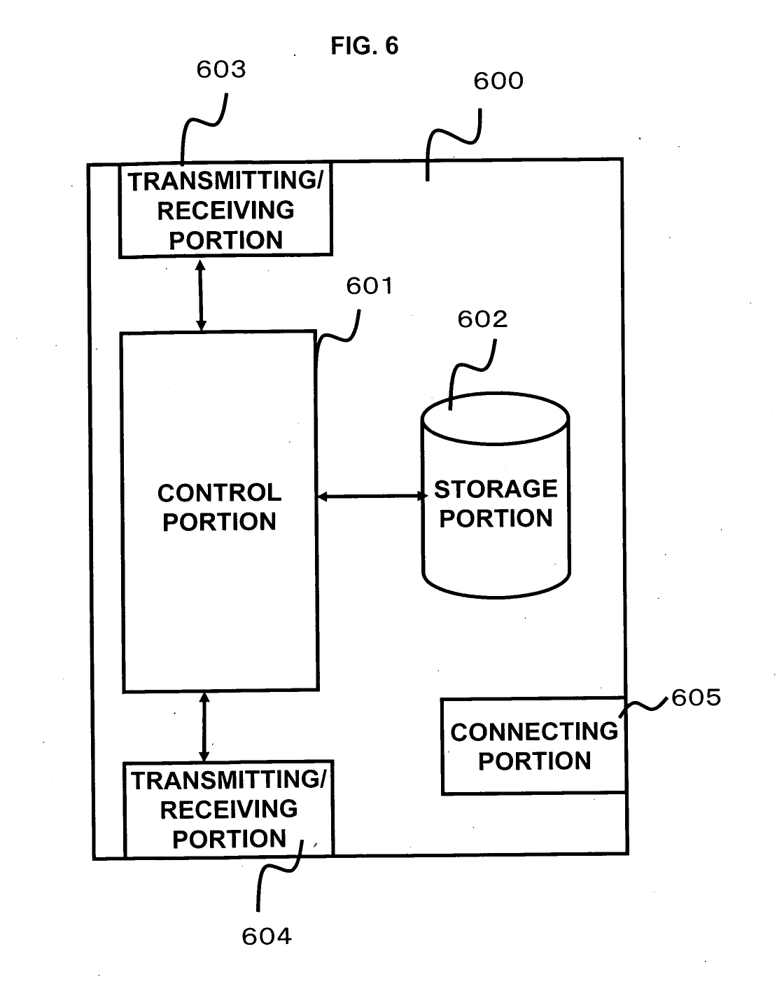

FIG. 6 is a hard block diagram according to an embodiment of the present invention.

A node 600 includes a control portion 601, a storage portion 602, a transmitting/receiving portion 603, a transmitting/receiving portion 604, and a connecting portion 605.

In the embodiment, the connecting portion 605 performs similar operation performed in the connecting means described in the claims. Operations performed in the response monitoring means, communication controlling means, information processing device connection determining means, and communication instructing means are similar to those performed in the control portion 601. Also, the storage portion 602 operates a similar operation performed in the storage means.

The node 600 is connected to a host computer by using the transmitting/receiving portion 603, and connected to a mass storage device by using the transmitting/receiving portion 604.

The node 600 is further connected to the other node by using the connecting portion 605. With the node connected through the connecting portion 605, the node 600 has a master-slave relationship, and in this embodiment, the node 600 is a slave node. Here, the slave node functions as a node which communicates with the host computer connected to the transmitting/receiving means 603 and the mass storage device connected to the transmitting/receiving means 604 in accordance with an instruction from a master node.

In the embodiment, only one transmitting/receiving portion 604 which connects to the mass storage device, and one connecting portion 605 which connects to the other node is described respectively, however, the present invention is not limited to the above, and more than one transmitting/receiving portion 604 or connecting portion 605 can be provided. Thus, it is not possible to connect the node 600 with a plurality of mass storage devices or a plurality of nodes.

The storage potion 602 stores a communication list. Here, the communication list shows nodes which communicate with the host computer and the mass storage device. Also, in the communication list, the master-slave relationship among nodes communicating with each other is shown, for example, the node 600 is a slave node, and one of the nodes connected to the node 600 is a master node.

In the embodiment, it is configured that nodes not shown in the communication list are not able to communicate with the host computer and the mass storage device.

Further, in the embodiment, a node simply referred to as a master node means a node connected to the node 600 and the node instructs the node 600 to communicate.

The control portion 601 performs an activation query notification which queries the master node if the master node is activated or not. Here, if a plurality of nodes is connected to the node 600, the control portion 601 performs the activation query notification to all of the nodes connected to the node 600 and shown in the communication list.

Then, the control portion 601 monitors a response to the activation query notification from the master node.

The control portion 601 waits for the response for a predetermined period of time. If there is no reply even if the predetermined period of time has passed, the control portion 601 acquires a master privilege so that communication with the host computer or the like becomes possible without an instruction from the master node. Here, the master privilege denotes a node that instructs the other nodes to communicate with the host computer and the mass storage device in the node configuration (the node group shown in the communication list) configured to communicate with the host computer and the master node.

If the reply has been made in the predetermined period of time, the connecting portion 605 continues to receive a notification which notifies that an incorporating process is required from the master node.

The control portion 601 requests the incorporating process of the master node and the incorporating process is performed. After the incorporating process is completed, the connecting portion 605 receives an incorporating process completion notification from the master node.

Then, the control portion 601 sets to be a state that the node 600 can communicate with the host computer and the mass storage device, and completes the setting.

Further, if there is no reply even if the predetermined period of time has passed, the control portion 601 determines that a node which is not shown in the communication list and connected to the node 600 exists or not.

If the control portion 601 determines a node which is not shown in the communication list is connected to the node 600, then the control portion 601 performs the incorporating process with the node.

The storage portion 602, in the communication list, deletes the previous master node which did not reply, sets the node 600 as a master node, adds the node to which the incorporating process was newly performed, and updates the communication list.

Thus, it can be possible for the node 600, even if a failure or the like occurs in the connected master node, can be possible to communicate with the host computer or the like. Further, it can be possible for the node 600 to perform the communication load distribution and retain the redundant configuration by adding the new node to the communication list.

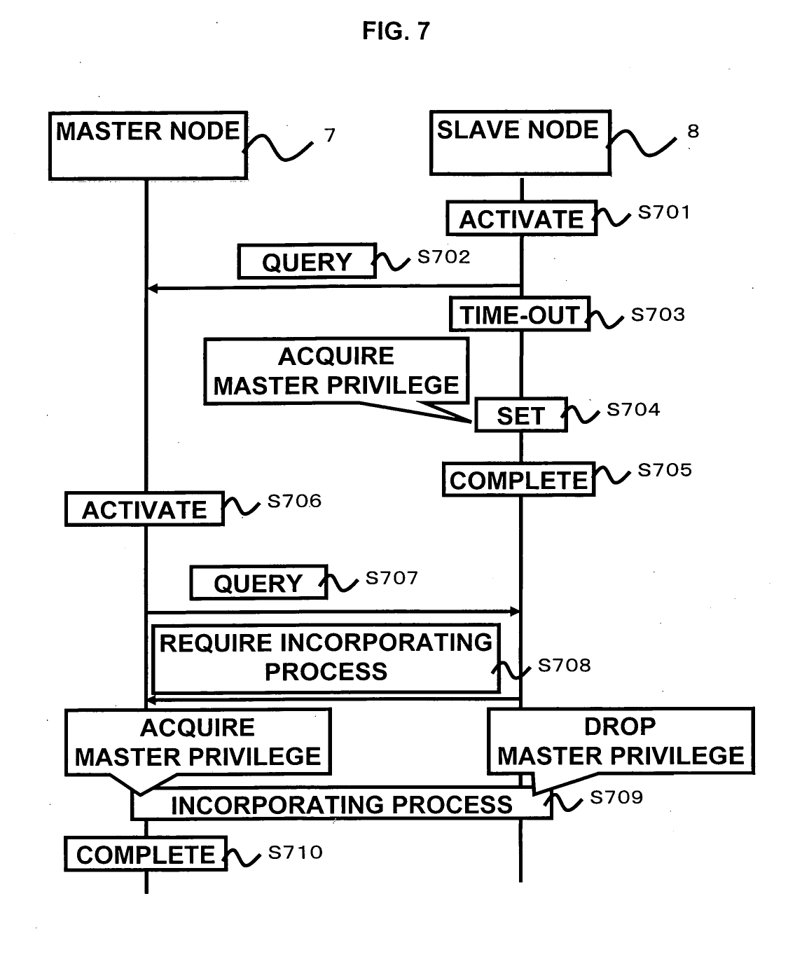

FIG. 7 is a sequence view in a case in which a master node 7 is not normally operating according to an embodiment of the present invention.

A slave node 8 is activated (step S701), and the slave node 8 queries the master node 7 whether the master node 7 is activated or not (step S702).

In the master node 7, a failure has occurred and the master node 7 is not able to reply to the slave node 8 that the master node 7 is activated.

The slave node 8 counts for a predetermined period of time until the master node 7 replies. If there is no reply from the master node 7 even if the predetermined period of time has passed, the slave node 8 considers it as a time-out (step S703).

Then, the slave node 8 acquires a master privilege, sets a process so that it is not possible for the slave node 8 to communicate with the host computer and the mass storage device without an instruction from the master node 7, and completes the process (steps S704, and S705).

The slave node 8 operates as a master node until the master node 7 is restored. If the slave node 8 (being operating as the master node) and other slave nodes exist, the slave node 8 instructs the other nodes to perform communication.

If the master node 7 is restored and activated (step S706), the master node 7 queries the slave node 8 whether the slave node 8 is activated or not (step S707).

The slave node 8 notifies the master node 7 that an incorporating process is required (step S708).

Then, the master node 7 and the slave node 8 perform the incorporating process (step S709).

At the step of the incorporating process, the master node 7 acquires a master privilege, the slave node 8 drops the master privilege, and the master node 7 instructs the nodes which configure the node configuration to communicate.

Then, the master node 7 completes the setting (step S710).

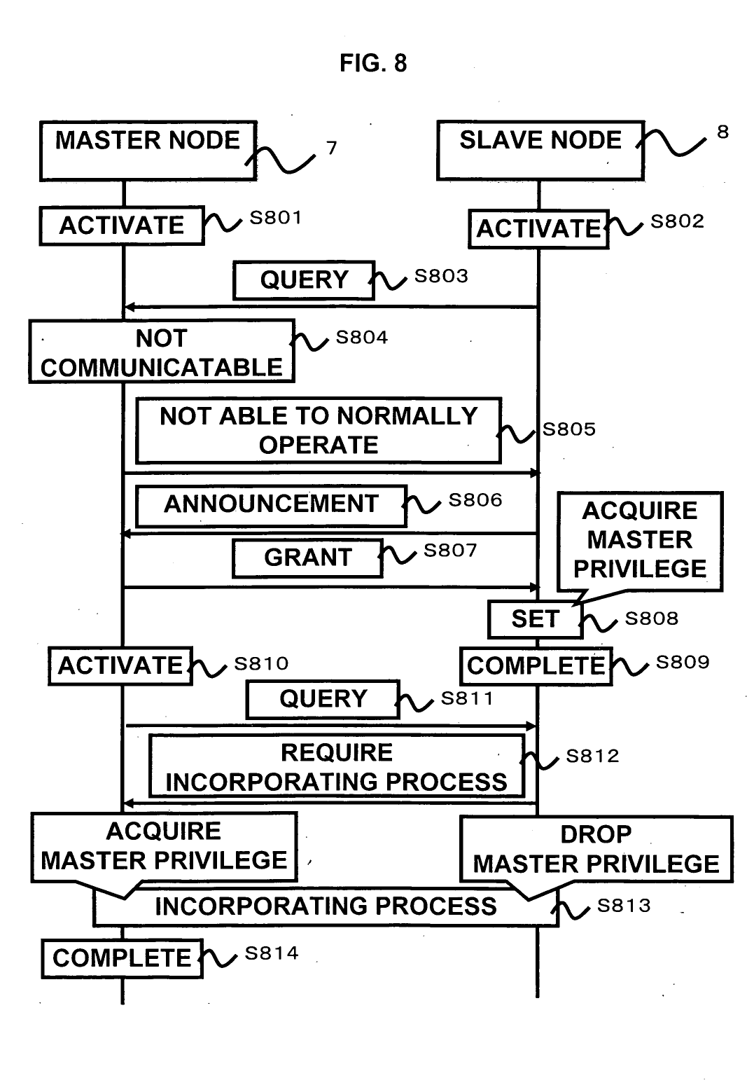

FIG. 8 is a sequence view illustrating a case in which the master node 7 is not physically connected to the host computer, the mass storage device, or the like according to an embodiment of the present invention.

If the master node 7 and the slave node 8 are activated (steps S801, and S802), the slave node 8 queries the master node 7 whether the master node 7 is activated or not (step S803).

The master node 7 determines that the master node 7 is not physically connected to the host computer, the mass storage device or the like, and is not communicatable (step S804).

The master node 7 replies to the slave node 8 that the master node 7 is not able to normally operate (step S805).

If the slave node 8 recognizes that the master node 7 is not able to normally operate, notifies the master node 7 of a preliminary announcement of acquisition of a master privilege (step S806).

The master node 7 notifies the slave node 8 that the master node 7 has granted the acquisition of the master privilege (step S807).

Then the slave node 8 acquires the master privilege, sets a process so that the slave node is able to communicate with the host computer or the like without an instruction from the master node 7, and completes the setting (steps S808 and S809)

If the master node 7 is restored and the master node is activated (step S810), the master node 7 queries the slave node 8 whether the slave node 8 is activated or not (step S811). The slave node 8 notifies the master node 7 that an incorporating process is required (step S812). Then the master node 7 and the slave node 8 perform the incorporating process (step S813). At the step of the incorporating process, the master node 7 acquires the master privilege, the slave node 8 drops the master privilege, and the master node 7 instructs the nodes which configure the node configuration to communicate. Then the master node 7 completes the setting (step S814).

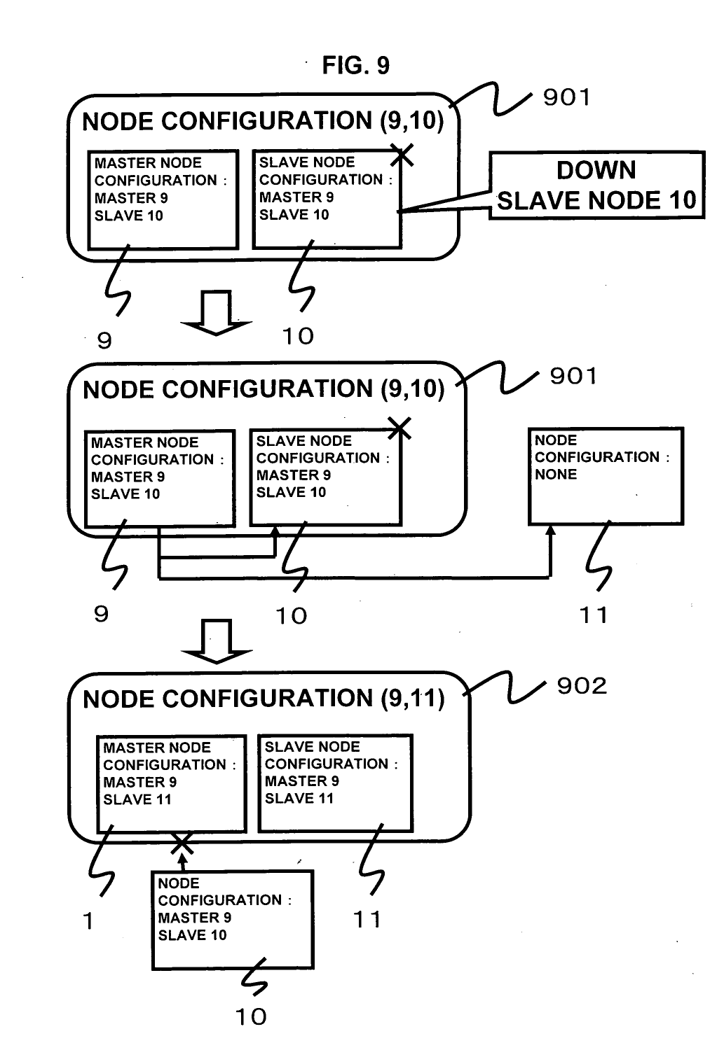

FIG. 9 is a conceptual view in a case in which a slave node is restored according to an embodiment of the present invention.

In the embodiment, a case in which a failure occurs in the slave node is shown. However, a similar restoring operation is performed if a failure occurs in a master node.

A master node 9 and a slave node 10 communicate with a host computer or the like.

The master node 9 and the slave node 10 respectively includes a communication list, and it is shown that a node configuration 901 is configured by using the master node 9 and the slave node 10.

If a failure occurs in the slave node 10 in the node configuration 901, the system goes down, and becomes to be uncommunicatable, and the master node 9 disconnects the slave node 10.

Then, it is determined whether any other node which is connected to the master node 9 and not being used for the communication exists or not.

If the master node 9 recognizes a node 11 which is connected to the master node 9, then, the master node 9 performs an incorporating process to incorporate the node 11 as a new node configuration. Here, “master 9” and “slave 10”described in the master node 9 and the slave node 10 respectively denotes the master node 9 and the slave node 10.

In the communication list which the node 11 has, before the incorporating process is performed, there is a description “nonexistence” which denotes that the node 11 does not configure any node and there is no node to configure.

The master node 9 and the node 11 configure a new node configuration 902. The node 11 functions as a slave node. Hereinafter, in the following description, the node 11 is referred to as a slave node 11.

The communication list which the master node 9 and the slave node 11 have are updated that the nodes configuring the new node configuration are the master node 9 and the slave node 11.

If the slave node 10 which went down is restored and activated, since the communication list which the master node 9 has is updated to the master node 9 and the slave node 11, the slave node 10 is refused to relate to the communication.

Then, the slave node 10 may request the master node 9 to perform an incorporating process so that it is possible for the slave node 10 to relate to a node configuration 903.

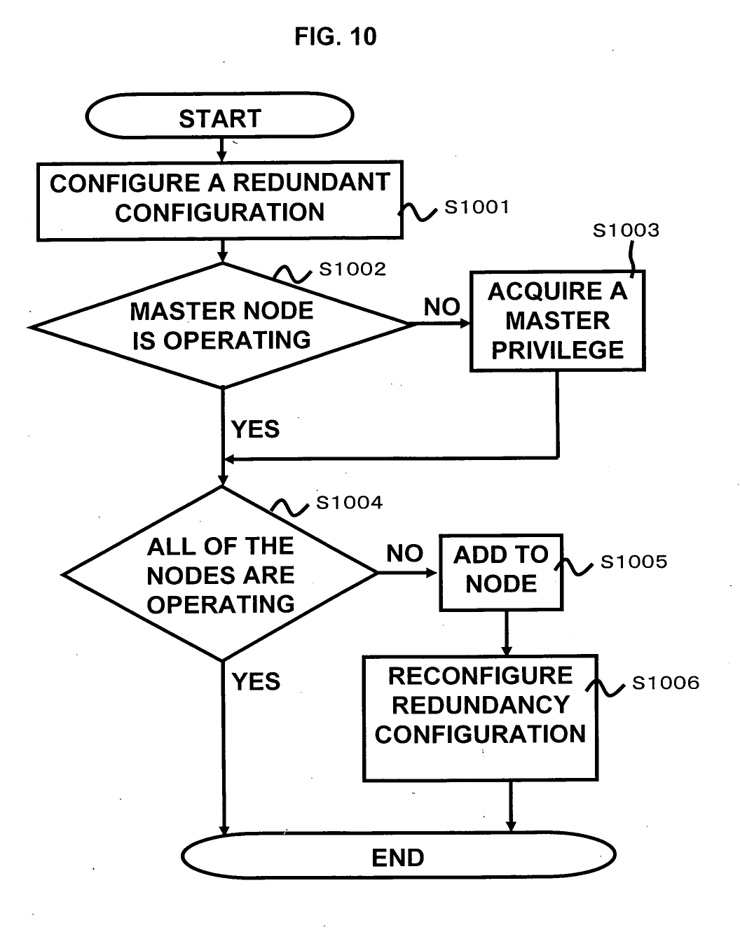

FIG. 10 is a flowchart according to an embodiment of the present invention.

If a master node and a slave node are activated, since the master node and the slave node perform a communication load distribution, a redundant configuration is configured (step S1001). Here, the redundant configuration denotes the node configuration described above.

Each node configuring the node configuration recognizes nodes which communicates with a host computer or the like. Moreover, it is determined in advance which node is a master and which node is a slave.

The slave node determines whether the master node is normally operating or not (step S1002).

If the slave node determines that the master node is not normally operating, the slave node acquires a master privilege (step S1003).

Further, if other nodes which are connected to the slave node and configured in the node configuration exist, the slave node determines whether all of the connected nodes are normally operating or not (step S1004).

If a node which is not normally operating exists in the nodes configured in the node configuration and connected, an emergency node which is not configured in the node configuration and is connected to the slave node is newly added to the node configuration (step S1005). Then, the inoperative node is switched to the emergency node so as to reconfigure the redundancy configuration (step S1006) and the process is completed.

At the step S1002, as well as a case in which it is determined that the master node is normally operating, if other nodes which are connected to the slave node and configured in the node configuration exist, the slave node determines whether all of the connected nodes are normally operating or not (step S1004).

If a node which is not normally operating exists in the nodes configured in the node configuration and connected to the slave node, an emergency node which is not configured in the node configuration and is connected to the master node is newly added to the node configuration (step S1005). Then, the inoperative node is switched to the emergency node so as to reconfigure the redundancy configuration (step S1006) and the process is completed.

What is claimed is:

1. An information processing device for communicating with an electronic device in accordance with an instruction from other information processing device connected to the electronic device, the information processing device comprising:
a connecting unit for connecting to the other information processing device, the connecting unit being connectable to a new or a plurality of new information processing devices;
a response monitoring unit for performing an activation query notification querying the other information processing device whether the other information processing device is activated or not, the response monitoring unit monitoring a response to the activation query notification from the other information processing device;
a communication controlling unit for allowing the electronic-device to be communicatable without an instruction from the other information processing device when the response has not been made;
an information processing device connection determining unit for determining whether any other new information processing device is connected by the connecting unit when the response monitoring unit determines that the response has not been made; and
a communication instructing unit for instructing the other new information processing device to communicate with the electronic device when the information processing device connection determining unit determines that the other new information processing device is connected.

2. The information processing device according to claim 1, wherein the response monitoring unit monitors whether the response from the other information processing device has been made or not for a predetermined period of time.

3. The information processing device according to claim 1, further comprising a response refusing unit for refusing the response by not allowing the communication with the electronic device by using the other information processing device, after the communication instruction unit instructed the other new information processing device to communicate with the electronic device, and when the response monitoring unit determines that the response from the other information processing device has been made.

4. An information processing device for communicating with an electronic device in accordance with an instruction from other information processing device connected to the electronic device, the information processing device comprising:
a connecting unit for connecting to the other information processing device, the connecting unit being connectable to a new or a plurality of new information processing devices;
a storage unit for storing a communication list which describes that the other information processing device instructs the information processing device to communicate with the electronic device with each other;
a response monitoring unit for performing an activation query notification querying the other information processing device whether the other information processing device is activated or not, the response monitoring unit monitoring a response to the activation query notification from the other information processing device;
a communication controlling unit allowing the electronic device to be communicatable without an instruction from the other information processing device when the response monitoring unit determines that the response has not been made;
an information processing device connection determining unit for determining whether any other new information processing device is connected by the connecting unit when the response monitoring unit determines that the response has not been made;
a communication instructing unit for instructing the other new information processing device to communicate with the electronic device when the information processing device connection determining unit determines that the other new information processing device is connected; and
a communication list updating unit for updating the communication list which describes that the information processing device communicates without the instruction from the other information processing device and the other information processing device does not communicate and the other new information processing device communicates.

5. The information processing device according to the claim 4, wherein the. response monitoring unit monitors whether the response from the other information processing device has been made or not for a predetermined period of time.

6. A communication load distribution method for communicating with an electronic device in accordance with an instruction from other information processing device connected to the electronic device, the communication load distribution method, executed by programmed processor, comprising the steps of:
connecting to the other information processing device and further allowing to be connectable to a new or a plurality of new information processing devices;
performing an activation query notification querying the other information processing device whether the other information processing device is activated or not, and monitoring a response to the activation query notification from the other information processing device;
allowing the electronic device to be communicatable without an instruction from the other information processing device when the response has not been made;
determining whether any other new information processing device is connected when the response has not been made; and
instructing the other new information processing device to communicate with the electronic device when the other new information processing device is connected.

7. The communication load distribution method according to claim 6, further comprising the step of:
monitoring whether the response from the other information processing device has been made or not for the predetermined period of time.
